(19) United States
(12) Patent Application Publication
(10) Pub. No.: US 2005/0181234 A1
(43) Pub. Date: Aug. 18, 2005

(54) Dispersion liquid composition for black matrix and image display device

(75) Inventors: Keisuke Iida, Tokyo (JP); Shogo Kitazawa, Tokyo (JP); Hidemi Matsuda, Tokyo (JP); Takeo Itou, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/082,687

(22) Filed: Mar. 18, 2005

Related U.S. Application Data
(63) Continuation of application No. PCT/JP03/11919, filed on Sep. 18, 2003.

(30) Foreign Application Priority Data
Sep. 19, 2002 (JP) 2002-273654

(51) Int. Cl. B32B 9/00

(52) U.S. Cl. 428/690

(57) ABSTRACT

A dispersion liquid composition for a black matrix, which includes a solvent, and at least one of light absorption material having an average particle diameter ranging from 10 to 500 nm and selected from the group consisting of manganese oxide and a solid solution containing manganese oxide and ferric oxide. It is possible, with the employment of this dispersion liquid composition, to form a light absorption layer which is capable of reducing the diffuse reflection factor as well as the mirror reflectivity thereof, thereby making it possible to obtain a display screen improved in properties as a black matrix.

### CROSS-REFERENCE TO RELATED APPLICATIONS

This is a Continuation Application of PCT Application No. PCT/JP03/11919, filed Sep. 18, 2003, which was published under PCT Article 21(2) in Japanese.

This application is based upon and claims the benefit of priority from prior Japanese Patent Application No. 2002-273654, filed Sep. 19, 2002, the entire contents of which are incorporated herein by reference.

### BACKGROUND OF THE INVENTION

1. Field of the Invention

The present invention relates to a dispersion liquid composition to be employed for the formation of the black matrix of image display screen. Further, the present invention relates to an image display device such as a cathode ray tube (CRT), a plasma display panel (PDP) and a field emission display (FED).

2. Description of the Related Art

Generally, in an image display device such as a color cathode ray tube, phosphor layers which are capable of emitting colors of blue (B), green (G) and red (R) on the inner surface of a glass substrate (panel) are arranged in a pattern of dots or stripes. As an electron beam is impinged against these phosphor layers, these colors are respectively emitted from these phosphors, thus creating a display image.

The display screen of such an image display device is constructed such that a light absorption layer (black layer) called a black matrix is interposed between the neighboring phosphor dots or phosphor stripes each constituting a pixel, in order to enhance the contrast of images through absorption of light other than that of these phosphors.

The characteristics of the black matrix can be represented by the diffuse reflection factor and mirror reflectivity of the light absorption layer. Namely, the smaller the values of these factors are, the more superior the characteristics of the black matrix become. Specifically, as the diffuse reflection factor becomes smaller, the diffuse reflection of the external light by the light absorption layer can be increasingly suppressed, thereby enhancing the light absorption effect. Further, as the mirror reflectivity of the light absorption layer becomes smaller, the reflection of light at the surface of the light absorption layer can be increasingly minimized, thereby making it possible to prevent the transfer of background light such as a fluorescent lamp to the display screen (see for example International Patent Publication No. 99/52122, page 5).

Incidentally, the diffuse reflection by the light absorption layer represents a state wherein the incident light entering from the outer surface of the panel is approximately equally reflected omnidirectionally at the interface between the panel and the light absorption layer. On the other hand, the mirror reflection represents a state wherein the light is mirror-reflected according to the law of reflection at the interface between the panel and the light absorption layer.

However, the conventional image display device such as the conventional color cathode ray tube is accompanied with the problem that the display screen having a light absorption layer as a black matrix is relatively high in diffuse reflection factor as well as in mirror reflectivity, as the light absorption layer is mainly constituted by graphite.

For example, it has been found out that when the light absorption layer was formed by spin-coating a dispersion liquid of graphite on a glass panel having a light transmittance of 70%, and the diffuse reflection factor and mirror reflectivity of this light absorption layer were measured, the diffuse reflection factor thereof was as high as 3.9% and the mirror reflectivity thereof was as high as 3.2%.

The present invention has been accomplished in view of overcoming this problem, and therefore, one object of the present invention is to provide a dispersion liquid composition for a black matrix, which is capable of obtaining a display screen improved in diffuse reflectivity and mirror reflectivity at the interface between a light absorption layer and a glass panel.

Another object of the present invention is to provide an image display device having a display screen which is excellent in image contrast as well as in reliability and which is capable of minimizing the transfer of background light to the display screen.

### BRIEF SUMMARY OF THE INVENTION

According to a first aspect of the present invention, there is provided a dispersion liquid composition for a black matrix, which comprises a solvent; and at least one light absorption material having an average particle diameter ranging from 10 to 500 nm and selected from the group consisting of manganese oxide and a solid solution containing manganese oxide and ferric oxide.

According to a second aspect of the present invention, there is also provided an image display device comprising a light transmitting panel; a light absorption layer formed on an inner surface of the panel; and a phosphor layer formed on the inner surface of the panel on which the light absorption layer is provided; wherein the light absorption layer includes at least one light absorption material having an average particle diameter ranging from 10 to 500 nm and selected from the group consisting of manganese oxide and a solid solution containing manganese oxide and ferric oxide.

### BRIEF DESCRIPTION OF THE SEVERAL VIEWS OF THE DRAWING

FIG. 1 is a cross-sectional view schematically illustrating the construction of a color cathode ray tube according to a second aspect of the present invention; and

FIG. 2 is a cross-sectional view illustrating the construction of the phosphor screen of the color cathode ray tube shown in FIG. 1.

### DETAILED DESCRIPTION OF THE INVENTION

The dispersion liquid composition for black matrix according to a first aspect of the present invention comprises a light absorption material having an average particle diameter ranging from 10 to 500 nm, more preferably 100 to 400 nm and selected from the group consisting of manganese oxide and a solid solution containing manganese oxide and ferric oxide. According to this dispersion liquid composition for black matrix which is formulated in this manner, it is possible to form a light absorption layer which is capable of reducing the diffuse reflection factor as well as the mirror reflectivity thereof, thereby making it possible to obtain a display screen provided with a black matrix having improved properties.

If an average particle diameter of manganese oxide or of a solid solution containing manganese oxide and ferric oxide in the dispersion liquid is larger than 500 nm in the dispersion liquid composition for black matrix according to a first aspect of the present invention, the mirror reflectivity of the light absorption layer to be formed would become undesirably high. On the other hand, if an average particle diameter of manganese oxide or of a solid solution containing manganese oxide and ferric oxide is smaller than 10 nm, the light transmittance of the light absorption layer may become extremely high, thereby badly deteriorating the light-shielding property thereof.

As for specific examples of the manganese oxides, it is possible to employ manganese dioxide (MnO₂), dimanganese trioxide (Mn₂O₃), trimanganese tetraoxide (Mn₃O₄) and dimanganese heptaoxide (Mn₂O₇).

As for the solid solution containing manganese oxide and ferric oxide (Fe₂O₃), it is possible to employ those containing manganese of 15% by weight or more. It is especially preferable to employ a solid solution containing manganese content ranging from 15 to 70% by weight. If the content of manganese is less than 15% by weight, it may be difficult to form a light absorption layer having a sufficient light-shielding property which is desirable as a black matrix of a cathode ray tube, etc.

The manganese or the solid solution containing manganese oxide and ferric oxide may preferably take a form of needle-like particles. In this case, the longest diameter of the needle-like particles should preferably be confined within the range of 50 to 500 nm, more preferably 150 to 450 nm. Incidentally, the average particle diameter “r” of the needle-like particles can be determined by the following formula:
r=(a+b)/2

wherein “a” is a longer diameter; and “b” is a shorter diameter.

It has been made clear from the comparison between a black matrix (light absorption layer) which was constituted by spherical particles and a black matrix (light absorption layer) which was constituted by needle-like particles having the same average particle diameter as that of the spherical particles, that in the case of the light absorption layer which was constituted by the needle-like particles, it was possible to form a large number of larger recessed/projected portions on the surface thereof as compared with the light absorption layer which was constituted by the spherical particles, so that it was possible to greatly minimize the mirror reflectivity even though the irregular reflection of light from the surface was permitted to increase.

Furthermore, since the distance between neighboring particles becomes closer in the case of the needle-like particles as compared with the spherical particles where the configuration thereof is relatively uniform, the linkage between particles can be made stronger and entanglement between particles is promoted due to the needle-like configuration. Accordingly, while there is a high possibility of generating so-called dag peeling of the light absorption layer from a glass substrate in the manufacturing process in the case of the light absorption layer which is constituted by spherical particles, there is little possibility of generating the peeling of particles in the case of the display screen where the light absorption layer is formed by making use of the needle-like particles, thus avoiding the generation of display defects.

According to the first aspect of the present invention, it is possible to incorporate a dispersant into the dispersion liquid composition in order to enable manganese oxide or a solid solution containing manganese oxide and ferric oxide to disperse uniformly in the solvent and to prevent the generation of secondary flocculation of particles.

As for the dispersant, it is possible to employ at least one material selected from the group consisting of aqueous acrylic resin which is a polymer or copolymer of acrylic acid, methacrylic acid or the derivatives thereof; sodium salt, ammonium salt or potassium salt of the aforementioned aqueous acrylic resin; polycarboxylic acid; lignosulfonic acid; and sodium salt, ammonium salt or potassium salt of bisphenol sulfonic acid.

As for the solvent, it is generally possible to employ water singly. However, it is also possible to employ a mixed solvent composed of water and an organic solvent which is compatible with water. As for specific examples of the organic solvent which is compatible with water, it is possible to employ alcohols such as ethanol, methanol and propanol; glycols such as ethylene glycol and propylene glycol; glycol ethers such as propyleneglycol monomethyl ether, propyleneglycol monoethyl ether; and polar solvents such as 2-pyrrolidone, N-methyl pyrrolidone, dimethylform amide and dimethylsulfoxide.

The content of the aforementioned manganese oxide or a solid solution containing manganese oxide and ferric oxide may preferably be confined within the range of 0.5 to 60% by weight, more preferably 5 to 35% by weight based on the total weight of the dispersion liquid. If the content of manganese oxide or the solid solution containing manganese oxide and ferric oxide is less than 0.5% by weight, it may become difficult to form a light absorption layer having a sufficient light-shielding property which is desirable as a black matrix of a cathode ray tube, etc. On the contrary, if this content is higher than 60% by weight, the viscosity of the dispersion liquid may become too high, thus it may become difficult to uniformly coat the dispersion liquid on the surface of the panel.

The color cathode ray tube according to the second aspect of the present invention is provided with a display screen which is formed using the dispersion liquid composition for a black matrix according to the first aspect of the present invention. According to this image display device, it is possible to realize an image display which is excellent in image contrast as well as in reliability and which is capable of minimizing the transfer of background light to the display screen and is free from the occurrence of defects.

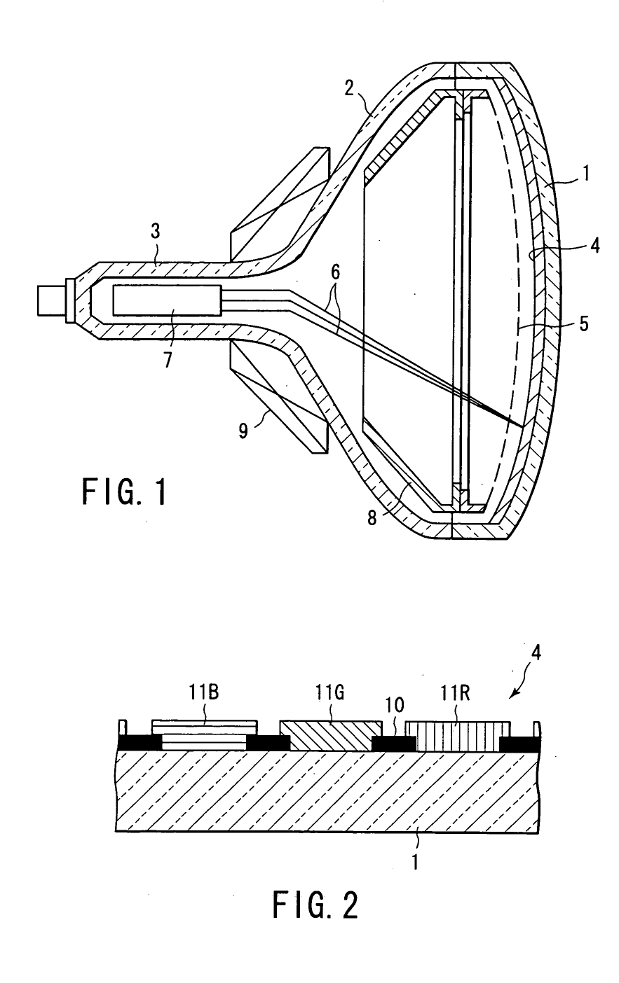

More specifically, as shown in FIG. 1, the color cathode ray tube according to the second aspect of the present invention comprises a housing consisting of a glass panel 1, a funnel 2 and a neck 3. On the inner surface of the panel 1, there is formed a phosphor screen 4. Further, on the inner side of the phosphor screen 4, there is also disposed a shadow mask 5 so as to face the phosphor screen 4.

On the other hand, an electron gun 7 for emitting an electron beam 6 is disposed in the neck 3 of the housing. Further, on the inner side of the funnel 2, there is disposed an inner shield 8 for shielding the electron beam 6 from being affected by an external magnetic field as the electron beam 6 is being emitted from the electron gun 7. On the outside of the funnel 2, there is disposed a deflecting device 9 for deflecting the electron beam 6 by making use of a magnetic field to be generated.

As shown in FIG. 2 by an enlarged scale, the phosphor screen 4 is constituted by a light absorption layer 10 which is formed in a pattern of dots and stripes, and a phosphor layer 11 formed in holes of prescribed configuration (for example, a circular dot-like configuration) formed in the light absorption layer 10, these holes being regularly arranged for emitting a blue luminescent color, a green luminescent color and a red luminescent color. The light absorption layer 10 includes, as a main component, a light absorption material having an average particle diameter ranging from 10 to 500 nm and consisting of manganese oxide or a solid solution containing manganese oxide and ferric oxide. As for specific examples of the manganese oxide or a solid solution containing manganese oxide and ferric oxide, the average particle diameter thereof falling within the aforementioned range, it is possible to employ, for example, needle-like particles made of MnO₂ or MnO₂/Fe₂O₃ and having a longer diameter falling within the range of 50 to 500 nm.

In order to enhance the color purity, an optical filter corresponding to the specific luminescent color of the phosphor layer 11 may be interposed between the phosphor layer 11 and the glass panel 1. Incidentally, in FIG. 2, the reference symbol 11B represents a phosphor layer for blue luminescent color, 11G represents a phosphor layer for green luminescent color and 11R represents a phosphor layer for red luminescent color.

The color cathode ray tube according to the second aspect of the present invention is featured in that the diffuse reflection factor and mirror reflectivity of the light absorption layer are relatively low, and that since the light absorption layer is provided with excellent properties desired as a black matrix and does not peel off during the manufacturing process thereof, it is possible to secure a high contrast and minimize not only the transfer of background light to the display screen but also the generation of defects.

In the foregoing explanation, although a color cathode ray tube has been discussed, the image display device of the present invention is not limited to the color cathode ray tube, but can be applied to a field emission display (FED), a plasma display panel (PDP), etc.

Next, examples of the present invention will be explained.

### EXAMPLES 1 AND 2

By making use of spherical particles (average particle diameter: 300 nm) made of a solid solution (MnO₂/Fe₂O₃) of manganese oxide and ferric oxide, and needle-like particles (longer particle diameter: 50-500 nm) made of MnO₂/Fe₂O₃, a dispersion liquid A (Example 1) and a dispersion liquid B (Example 2) each having the following compositions were respectively prepared.

[Composition of dispersion liquid A]

| | |
|---|---|
| Spherical particles of MnO₂/Fe₂O₃ | 15 wt % |
| Dispersant (sodium salt or ammonium salt of | 1.5 wt % |
| aqueous acrylic resin) | |
| Water | 83.5 wt % |

[Composition of dispersion liquid B]

| | |
|---|---|
| Needle-like particles of MnO₂/Fe₂O₃ | 15 wt % |
| Dispersant (sodium salt or ammonium salt of | 1.5 wt % |
| aqueous acrylic resin) | |
| Water | 83.5 wt % |

By making use of these dispersion liquid A and dispersion liquid B, a light absorption layer was formed as a black matrix on the inner surface of each of the 17-inch CRT glass panels (100 sheets in total) having a light transmittance of 70%. The light absorption layer was formed as follows.

First of all, a photoresist was coated on the inner surface of the glass panel by means of spin coating method and allowed to dry to form a photoresist layer. Then, this photoresist layer was exposed to light through a shadow mask and developed to form a dot-like resist pattern. Subsequently, the dispersion liquid A and the dispersion liquid B were coated over the resist pattern by means of spin coating method and allowed to dry to form a light absorption material film. Then, a resist decomposition liquid such as an aqueous hydrogen peroxide solution was applied to the film to dissolve and remove concurrently the resist and part of the light absorption material film located on the resist, thereby forming a light absorption layer.

Further, as a comparative example, graphite which has been conventionally employed, and a dispersant (carboxymethyl cellulose) were mixed together to prepare a dispersion liquid C, which was then employed in the same manner as explained in Examples 1 and 2 to form a light absorption layer on the surface of a glass panel.

The glass panels (100 sheets in each example) each having the light absorption layer formed as described above were investigated with respect to the number of so-called dag peeling of the light absorption layer and to the number of other defects generated, thus determining the number of nondefective product and the yield thereof.

Then, by making use of the dispersion liquids A, B and C in Examples 1 and 2 and Comparative Example, a phosphor screen including a dot-like blue luminescent layer, a dot-like green luminescent layer and a dot-like red luminescent layer was formed on the surface of the 17-inch CRT glass panel having a black matrix (light absorption layer) formed thereon.

The pattern of the blue luminescent layer was formed as follows. Namely, a slurry containing a blue phosphor (ZnS:Ag,Al) was coated, by means of spin coating method, on the surface of the glass panel having a black matrix formed thereon. The coated layer was then allowed to dry to form a blue phosphor layer, which was then exposed to light through a shadow mask and developed and wash out to remove uncured portions, thus forming the pattern of the blue luminescent layer. Then, in the same manner as in the case of forming the blue luminescent layer, by making use of a slurry containing a green phosphor (ZnS:Cu,Al), a pattern of the green luminescent layer was formed. Likewise, by making use of a slurry containing a red phosphor (Y₂O₂:Eu), a pattern of the red luminescent layer was formed. Subsequently, according to the ordinary procedures, a color cathode ray tube was completed.

Each of the color cathode ray tubes constructed in this manner was subjected to measurements with regard to the diffuse reflection factor Rr(%) and mirror reflectivity Rm(%) of the light absorption layer, both being measured from the glass panel side.

Namely, the diffuse reflection factor and mirror reflectivity were measured by the methods as described below. Namely, in the measurement of the diffuse reflection factor, the color cathode ray tube was placed in a dark room with the outer surface of the glass panel being directed upward, and the light of fluorescent lamp was irradiated against the glass panel at an angle of 45 degrees to the normal line which was depicted perpendicularly from the center of the panel. Thereafter, by making use of a luminance meter disposed on this normal line, the reflection luminance to a white diffusion plate (reflectance: 99.9%) was measured. Then, the value thus obtained was converted to an absolute reflectance to determine the diffuse reflection factor.

Further, in the measurement of the mirror reflectivity, in the same manner as described above, the color cathode ray tube was placed in a dark room with the outer surface of the glass panel being directed upward, and the light of fluorescent lamp was irradiated against the glass panel at an angle of 45 degrees to the normal line which was depicted perpendicularly from the center of the panel. Thereafter, by making use of a luminance meter disposed at an angle of 45 degrees to this normal line and placed on the opposite side to the irradiation, the reflection luminance to a white diffusion plate was measured. Then, the value thus obtained was converted to an absolute reflectance to determine the reflectance.

The results measured with regard to the diffuse reflection factor and the mirror reflectivity are summarized in the following Table 1 together with the aforementioned number of nondefective product and the yield.

TABLE 1

| | | | Comparative |
|---|---|---|---|
| | Example 1 | Example 2 | Example |
| Dispersion | A | B | C |
| liquid | | | |
| Light | Spherical | Needle-like | Graphite |
| absorption | particles | particles | |
| material | of MnO₂.Fe₂O₃ | of MnO₂.Fe₂O₃ | |
| Total number | 100 | 100 | 100 |
| of panels | | | |
| Number of | 90 | 97 | 96 |
| nondefective | | | |
| product | | | |
| Yield (%) | 90 | 97 | 96 |
| Number of | 6 | 0 | 0 |
| dag peeling | | | |
| Number of | 4 | 3 | 4 |
| other | | | |
| defectives | | | |
| Diffuse | 2.9 | 3.0 | 3.9 |
| reflection | | | |
| factor (%) | | | |
| Mirror | 1.3 | 0.75 | 3.2 |
| reflectivity | | | |
| (%) | | | |

It will be seen from this Table 1 that in the case of the color cathode ray tube of Example 1 wherein the black matrix was formed by making use of the dispersion liquid A containing spherical particles of MnO₂/Fe₂O_{3,} it was possible, in comparison with the color cathode ray tube of Comparative Example where the black matrix was formed using the dispersion liquid C containing graphite, to decrease not only the diffuse reflection factor but also the mirror reflectivity of the black matrix even though the yield was more or less deteriorated due to the dag peeling, thereby making it possible to greatly improve the reflectance of the display screen.

In the case of the color cathode ray tube of Example 2 wherein the dispersion liquid B containing needle-like particles of MnO₂/Fe₂O₃ was employed, the diffuse reflection factor of the black matrix was 1.1%, and the mirror reflectivity thereof was 0.75%, thus, as compared with the color cathode ray tube of Comparative Example, the value of the diffuse reflection factor was decreased by about 25%, and the value of the mirror reflectivity was decreased by about 75%, thereby indicating prominent improvement over the prior art in terms of the reflectance of the display screen. Further, even in comparison with the color cathode ray tube of Example 1, it was possible to improve the diffuse reflection factor by about 40%. Moreover, the color cathode ray tube of Example 2 was found completely free from the generation of dag peeling and the yield in Example 2 was found improved by 1% as compared with the color cathode ray tube of Comparative Example.

1. A dispersion liquid composition for a black matrix, which comprises:
a solvent; and
at least one light absorption material having an average particle diameter ranging from 10 to 500 nm and selected from the group consisting of manganese oxide and a solid solution containing manganese oxide and ferric oxide.

2. The dispersion liquid composition for a black matrix according to claim 1, wherein said manganese oxide is selected from the group consisting of manganese dioxide, dimanganese trioxide, trimanganese tetraoxide and dimanganese heptaoxide.

3. The dispersion liquid composition for a black matrix according to claim 2, wherein said manganese oxide is manganese dioxide.

4. The dispersion liquid composition for a black matrix according to claim 1, wherein said solid solution containing manganese oxide and ferric oxide contains not less than 15% by weight of manganese.

5. The dispersion liquid composition for a black matrix according to claim 1, wherein said manganese oxide and said solid solution containing manganese oxide and ferric oxide take a form of spherical or needle-like particles.

6. The dispersion liquid composition for a black matrix according to claim 5, wherein said manganese oxide and said solid solution containing manganese oxide and ferric oxide take a form of needle-like particles.

7. The dispersion liquid composition for a black matrix according to claim 6, wherein said needle-like particles have a longest diameter ranging from 50 to 500 nm.

8. The dispersion liquid composition for a black matrix according to claim 1, wherein said solvent is water or a mixed solvent containing water and an organic solvent which is compatible with water.

9. The dispersion liquid composition for a black matrix according to claim 8, wherein said organic solvent which is compatible with water is at least one material selected from the group consisting of alcohols, glycols, glycol ethers and a polar solvent.

10. The dispersion liquid composition for a black matrix according to claim 1, which further comprises a dispersant.

11. The dispersion liquid composition for black matrix according to claim 10, wherein said dispersant is at least one material selected from the group consisting of aqueous acrylic resin; sodium salt, ammonium salt or potassium salt of aqueous acrylic resin; polycarboxylic acid; lignosulfonic acid; and sodium salt, ammonium salt or potassium salt of bisphenol sulfonic acid.

12. The dispersion liquid composition for a black matrix according to claim 1, wherein a content of said light absorption material is 0.5 to 60% by weight based on the entire weight of the dispersion liquid.

13. An image display device comprising:
a light transmitting panel;
a light absorption layer formed on an inner surface of said panel; and
a phosphor layer formed on the inner surface of said panel on which said light absorption layer is provided;
wherein said light absorption layer includes at least one light absorption material having an average particle diameter ranging from 10 to 500 nm and selected from the group consisting of manganese oxide and a solid solution containing manganese oxide and ferric oxide.

14. The image display device according to claim 13, wherein said manganese oxide is selected from the group consisting of manganese dioxide, dimanganese trioxide, trimanganese tetraoxide and dimanganese heptaoxide.

15. The image display device according to claim 14, wherein said manganese oxide is manganese dioxide.

16. The image display device according to claim 13, wherein said solid solution containing manganese oxide and ferric oxide contains not less than 15% by weight of manganese.

17. The image display device according to claim 13, wherein said manganese oxide and said solid solution containing manganese oxide and ferric oxide take a form of spherical or needle-like particles.

18. The image display device according to claim 17, wherein said manganese oxide and said solid solution containing manganese oxide and ferric oxide take a form of needle-like particles.

19. The image display device according to claim 18, wherein said needle-like particles have a longest diameter ranging from 50 to 500 nm.
